(19) United States
(12) Patent Application Publication
(10) Pub. No.: US 2011/0153933 A1
(43) Pub. Date: Jun. 23, 2011

(54) DATA STORAGE ON WRITEABLE REMOVABLE MEDIA IN A COMPUTING DEVICE

(75) Inventor: Peter Scobie, Northants (GB)

(73) Assignee: SYMBIAN SOFTWARE LTD., London (GB)

(21) Appl. No.: 12/063,086

(22) PCT Filed: Aug. 8, 2006
(86) PCT No.: PCT/GB06/02972

§ 371 Date: Jun. 16, 2010

(30) Foreign Application Priority Data
Aug. 10, 2005 (GB) 0516450

(51) Int. Cl. G06F 12/00

(52) U.S. Cl. 711/115; 711/E12.001

(57) ABSTRACT

On a computing device making use of removable storage media, the mechanical nature of the process for removing of the media enables the device to detect the beginning of this process before it reaches the point where the removable media has been removed to the extent that it is no longer operable. The minimum time taken to reach this point from the detection of the beginning of the process is with the present invention used to compute the size a data chunk which is guaranteed to be completely written provided the write begins before the start of removal is detected. By breaking down all lengthy write operations into chunks which can be written within this minimum time period, the risk of corruption of the removable media and the loss of data can be eliminated.

This invention describes a method of avoiding corruption of data on a computing device owing to the premature removal of removable media.

The term ‘computing device’ includes, without limitation, personal devices such as desktop computer, laptop computers, PDAs, Mobile Telephones, Smartphones, Digital Cameras and Digital Music Players. It also includes converged devices incorporating the functionality of one or more of the classes of device already mentioned, together with many other industrial and domestic electronic appliances.

Computing devices typically have multiple strategies for storing data. The internal random access memory (RAM) on such devices is fast in operation, but it is volatile and loses its contents when powered off (non persistent). Other types of storage commonly used are persistent and do not lose their contents. These include magnetic storage such as tapes and the various types of disk drives, optical drives such as the various types of compact disks (CDs) and digital video disks (DVDs) and many other types of non-volatile solid state devices such as flash drives. Many of these types of storage may be either fixed or removable relative to the computing device.

Modern computing devices often include fixed non-removable persistent storage; examples familiar to many people include the hard disk drives inside desktop and laptop personal computers and the flash memory used in many personal digital assistants (PDAs) and advanced mobile telephones.

However, removable persistent storage has certain advantages. A major advantage is that, within limits, it makes the storage capacity of any computing device easily and almost infinitely upgradeable. It also offers additional options for installation of software and other digital content to a device. Furthermore, because it facilitates the movement of data from one device to another, it offers additional convenient options over the use of fixed storage for both backup and security.

There are some notable disadvantages of removable persistent storage however. The major ones relate to security and fragility; typically, the removable media used for such storage, such as floppy disks, CDs, DVDs, and the various types of flash memory storage, are much more easily damaged when off the computing device than when mounted on the device. Furthermore, the chances of misplacement, loss and theft of removable media when off the device are high in comparison to when these media are mounted on the computing device. Additionally, the physical act of removing and inserting the media to the computing device can damage both the computing device and the removable media.

This final cause of damage can happen for a number of reasons, including clumsiness on the part of a user, and the presence of adverse environmental conditions such as static electricity or moisture. The majority of everyday users of such removable media do not appreciate that damage can also be caused by premature removal of the media while the computing device is in the process of writing to it, and premature removal of such media can often be observed in practice. This can cause corruption not only of the block of data currently being written, but can also damage the set of data of which it is a part (such as a file). In the worst case, sensitive data on the media (such as the root directory) can be irreparably corrupted, or the removable media electronic circuits themselves can be damaged, which can render the entire content of the removable media inaccessible.

This can be especially serious in the case of modern flash memory devices such as Compact Flash (CF) cards, Multimedia Cards (MMC), Secure Digital (SD) cards, Memory Sticks (MS) and Extreme Digital (XD) cards because these devices are now available with large amounts of storage capacity and typically are used to store large amounts of data. Furthermore, these devices are often in almost continuous use as fast random-access file stores. They are also relatively expensive to purchase.

Many computing devices make no provision whatsoever for minimising damage caused to removeable media by premature removal during write operations. The ones that do have such provision rely on physically preventing removal of the media. Examples of this category include CD and DVD drives in which the eject mechanism is entirely electronic and is controlled by software on the device, and disk drives with a manually operated door latch that can be software locked.

Such locking mechanisms are more expensive to manufacture than simple mechanical devices; they are also bulkier, heavier and consume more power. As such, they are particularly unsuitable for resource-constrained mass market consumer devices such as advanced mobile telephones and digital cameras, which have limited battery life, need to be as light and compact as possible, and are also under considerable market pressure to be manufactured as inexpensively as possible,

While it is certainly possible to prevent the damage caused by premature removal of media during a write operation by physically preventing such removal, this is not the only method of achieving this goal.

The perception underlying this invention is that it is logically possible to prevent the damage caused by premature removal of media during a write operation by ensuring that write operations have completed before removal of the media occurs.

According to a first aspect of the present invention there is provided a method of storing data on a removable media on a computing device, the method comprising subdividing data storage operations into a plurality of smaller data storage operations, each of which is known to take less time to complete than is taken by the user of the device to remove from the device the media on which the data is being stored.

According to a second aspect of the present invention there is provided a computing device arranged to operate in accordance with a method of the first aspect.

According to a third aspect of the present invention there is provided an operating system for causing a computing device to operate in accordance with a method of the first aspect.

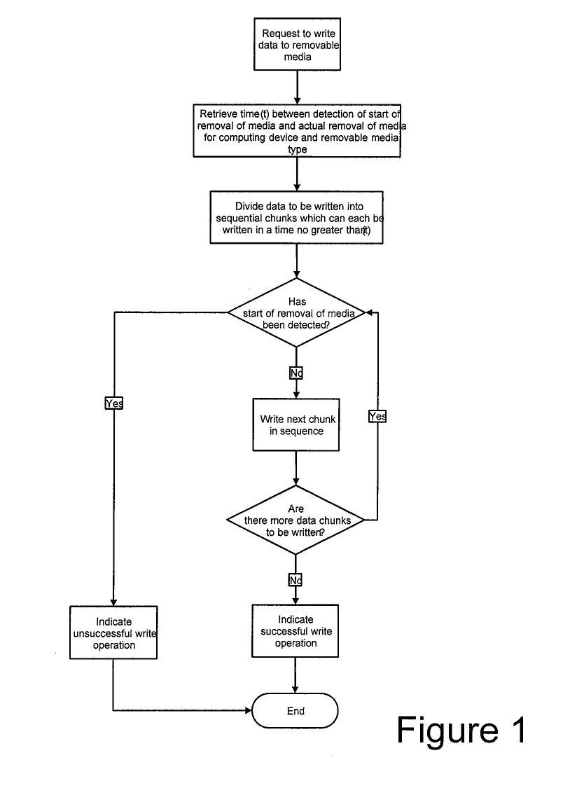

Embodiments of the present invention will now be described, by way of further example only, with reference to FIG. 1, which shows a method of safe drive removal in accordance with the present invention.

The method which this invention discloses as to how safe removal of a removable drive may be effected is for all write operations to removable media to be broken down into small discrete chunks. If this is done, then even if the drive is removed suddenly, there is sufficient time for the system to write the latest information chunk to the removable drive before the drive is actually removed and the write process has to be aborted. In this way there is minimal risk of creating an area on the removable drive that gives rise to read errors.

The present invention detects when the removable media is about to be extracted or ejected from the computing device. The method of achieving this relies on the fact that removal of the media is a relatively complex mechanical operation that, in computing terms, takes a very long time; typically in the order of a second rather than nanoseconds, and the occurrence of such a lengthy operation can be detected before it reaches a stage where writing to the media becomes a dangerous and risky operation.

Computing devices frequently have their removable media protected by a physical barrier, such as a door which has to be opened before the media can be removed from the computing device. In such a case, the opening of the physical barrier can be detected, for example, by the addition of a small microswitch which detects the initial stages of opening of the barrier.

Computing devices may require devices to be ejected by means of a spring-loaded mechanism, the operation of which is initiated by a trigger (which may be either the removable media itself or a small button which must firstly be pushed in before the media can be removed. This provides the spring with enough energy to eject the removable media when the trigger is released. In such a case, the pressing of the trigger can be detected by the addition of a small microswitch or other sensor, such as a piezoelectric sensor, to the device.

Computing devices which have neither door nor triggers and make use of one or more of the solid state storage cards, such as the aforementioned CF, MMC, SD, MS and XD cards, can make use of the fact that the pins or connectors on such media are relatively long, and take a relatively long finite time (in computing terms) to be moved to a position where they are no longer in electrical contact with co-operating socket contacts on the computing device to which the removable media has been attached. The commencement of the removal process can be detected by means of a microswitch or other suitable motion detecting transducer inside the device which is triggered as soon as the media is caused to be moved back from the normal operational position. Alternatively, a shorter contact on an unused or non-critical pin or connector could be used to enable the initiation of removal to be detected.

In all the above cases, an empirical calibration of the minimum time it takes from the detection of a start of a removal event to the actual removal of the drive, together with knowledge of the write speed of the removable media, enables the designer of the device and its controlling software to compute the optimum size of a chunk of data that may be written to the media without risk of actual removal occurring before that chunk of data has been written to the media. Once the size of this chunk of data is known, it will always be safe to write it to the removable media as long as no start removal event has occurred, because even if such a removal event does occur during a write process, that write process is guaranteed to be able to complete before the removal reaches a critical stage where writing to the removable media becomes impossible to continue.

The point at which writing to the removable media becomes impossible will depend on the speed with which the removable media is physically removed, and clearly this will vary from user to user, from one example of a media type to another, from device to device, and will also vary with the age of the device. The elasticity of springs, the smoothness of door opening, the precision of the engineering of the removal media and the physical dexterity of the fingers of the user all play their part. The safest course to adopt is to take the earliest point of removal that can be reliably reproduced.

It is possible that manufacturers of computing devices may find that the performance in general of devices which use this invention are improved by introducing measures to make the removal of media slightly more burdensome to provide only a small increase in time to remove the media from the computing device, since this small increase in time is relatively large in computing terms which means that the size of the chunk of data that can be safely and reliably written to the removable media can be made considerably larger and, overall, writing to removable media can be made more efficient.

By means of this invention, the risk of the corruption of data on removable media arising from premature removal may be significantly reduced or completely eliminated.

A more detailed description of an embodiment of the invention will now be provided. In this embodiment, the computing device is a mobile telephone, the removable media hardware is an MMC card equipped with a media storage door as described above, and it is assumed that there are drive controller and device driver components in the computing device which are responsible for the hardware (power and door open detection) and software (data bus operation) operations of the removable media.

When the drive controller detects a door-open event, it attempts to remove power from the MMC card as quickly as possible. However, it does not remove the power immediately if a bus operation is in progress, because it is inadvisable to remove power from such a card in the middle of writing a block, as this could corrupt the block. In this case, power-down is deferred until the end of the MultiMediaCard session. But, attempts to engage a new session while the door is open will fail immediately though.

Thus, to avoid the situation in which a card is physically unplugged while a command is still completing, driver requests are kept sufficiently short to ensure that they can always be completed in the time between the door open event and the actual time that the card becomes electrically decoupled from the computing device. This means that long multi-block write commands have to be avoided, despite the improved data transfer they provide over shorter block transfers. Because of this, it is very important that the mobile phone is provided with a mechanism and circuitry that gives early warning of potential card removal.

The overall process is shown in FIG. 1. In response to a request to write data to removable media, a device according to the invention retrieves a time (t), based upon the time taken between detection of the start of the removal of the media and actual removal of the media for the device in question, and the removable media type. The method by which the time (t) is determined is not part of the present invention but could for example be achieved during setup of the device for a particular user and different forms of media storage types, with the determined times for the various media types being stored in the device.

The data to be written is then divided into sequential chunks which can each be written to the media in a time no greater than (t). The device then determines whether the start of removal of the media has been detected. If the answer is ‘no’ the next data chunk in the sequence is written to the media. This process is repeated until all of the media chunks are written, and once all of the data chunks are written, the device preferably provides an indication of a successful write operation.

However, if at any time during the write process, the start of removal of the media is detected, then the whole of the write operation cannot be completed and an indication of an unsuccessful write operation is provided to the user. The data being written is then incomplete and in all probability cannot be used, but because the write interrupt cause by the removal of the media has not occurred during the actual writing of a chunk of the data, this ensures that the media itself does not become corrupted.

Hence, this invention enables removable media to be used on computing devices without the danger of data loss due to premature removal, and this is achieved without any expensive, bulky, heavy or power hungry mechanical devices.

On a computing device making use of removable storage media, the mechanical nature of the process for removing of the media enables the device to detect the beginning of this process before it reaches the point where the removable media has been removed to the extent that it is no longer operable. The minimum time taken to reach this point from the detection of the beginning of the process can be used to compute the size of a data chunk which is guaranteed to be completely written provided the write begins before the start of removal is detected. By breaking down all lengthy write operations into chunks which can be written within this minimum time period, the risk of corruption of the removable media and the loss of data can be eliminated.

Although the present invention has been described with reference to particular embodiments, it will be appreciated that modifications may be effected whilst remaining within the scope of the present invention as defined by the appended claims.

1. A method of storing data on a removable media on a computing device, the method comprising subdividing data storage operations into a plurality of smaller data storage operations, each of which is known to take less time to complete than is taken by the user of the device to remove from the device the media on which the data is being stored.

2. A method according to claim 1 wherein the time taken by the user of the device to remove the media on which the data is being stored is measured from the point at which removal of the media is first detected to the point at which data storage is known to be no longer possible.

3. A method according to claim 2 wherein the point at which removal of the media is first detected is determined by means of the physical opening of a door or cover which it is necessary to displace before gaining access to the media.

4. A method according to claim 2 wherein the point at which removal of the media is detected is determined by means of a transducer triggered by the compression of a spring used to eject the media.

5. A method according to claim 2 wherein the point at which removal of the media is detected is determined by means of a transducer which is triggered by the movement of the media from its normal operational position.

6. A method according to claim 2 wherein the point at which removal of the media is detected is determined by means of the opening of electrical contacts which are closed when the media is in its operational position.

7. A method according to claim 2 wherein the point at which data storage is known to be no longer possible is determined by taking the earliest point that can be reliably reproduced by a user during removal of the media from the computing device.

8. A computing device arranged to operate in accordance with a method as claimed in claim 1.

9. A computing device according to claim 8 comprising means for ensuring that the time taken by a user of the device to remove the media on which the data is being stored exceeds a predetermined threshold.

10. An operating system for causing a computing device to operate in accordance with a method as claimed in claim 1.
